(19) United States
(12) Patent Application Publication
(10) Pub. No.: US 2009/0170562 A1
(43) Pub. Date: Jul. 2, 2009

(54) Speed dial configuration of a mobile terminal for a mobile telecommunications network from a remote service

(75) Inventors: Antti Kujala, Helsinki (FI); Miika Silfverberg, Vantaa (FI)

Correspondence Address: PERMAN & GREEN, 425 POST ROAD, FAIRFIELD, CT, 06824, US

(73) Assignee: NOKIA CORPORATION, Espoo (FI)

(21) Appl. No.: 12/088,018

(22) PCT Filed: Sep. 28, 2005
(86) PCT No.: PCT/IB05/02998

§ 371 Date: Dec. 3, 2008

(51) Int. Cl. H04M 1/00

(52) U.S. Cl. 455/564

(57) ABSTRACT

The method is presented for speed dial configuration of a mobile terminal for a mobile telecommunications network. The method involves the following steps in the mobile terminal. A speed dial command is detected from a user of the mobile terminal, whereupon communication is established with a remote service over the mobile telecommunications network. First information pertaining to a desired communication party is provided to the remote service. In return, configuration data containing second information pertaining to the desired communication party is received from the remote service, the second information including a caller identity of the desired communication party. Finally, the mobile terminal is configured for future speed dialing to the desired communication party by storing, in local memory in the mobile terminal, an association between the speed dial command and the caller identity. An associated method, mobile terminal, remote service apparatus, system and computer program are also presented.

### CROSS-REFERENCE TO RELATED APPLICATIONS

This application is the National Stage of International Application No. PCT/IB2005/002998, International Filing Date, 2005 Sep. 28, which designated the United States of America, and which international application was published under PCT Article 21(2) as WO Publication No. WO 2007/036760, the disclosure of which is incorporated herein by reference in its entirety.

### BACKGROUND

1. Field

The disclosed embodiments relate to mobile telecommunication and more particularly to methods, a mobile terminal, a remote service apparatus, a system and a computer program for speed dial configuration of a mobile terminal for a mobile telecommunications network from a remote service coupled to the mobile telecommunications network.

2. Brief Description

A mobile (cellular) telephone for a telecommunications system like GSM, UMTS, D-AMPS, CDMA2000, FOMA or TD-SCDMA will be used as an example of a mobile terminal according to the above. As is well known in the field, a user of such a mobile terminal frequently establishes telecommunication with other users of remote telecommunication devices. The most well-known way is, of course, by placing a telephone call from the mobile terminal to for instance a stationary, mobile or satellite telephone, or a computer with IP telephony capabilities. Such a telephone call may be initiated in different ways by an experienced user. The user may select a contact in a contacts (phonebook) application and cause a call to that contact by choosing a menu option, etc. Alternatively, an option may be selected in a messaging application to make a call to a sender of a certain electronic message (e.g. SMS, MMS or email), or a new call may be made to any of the communication parties listed in a recent calls list.

However, even of these alternatives are convenient and popular among experienced users, they may be difficult or even unknown to other user categories, such as elderly people, people with certain handicaps, illiterate people or people that are newcomers to the world of mobile telecommunications. Such users often stick to traditional manual dialing in a call handling application (idle screen); the telephone number of the desired communication party is entered by repeatedly pressing respective (alpha-)numeric keys (“0”-“9”, “*”, “#”) on an ITU-T-type keypad (or by repeatedly selecting corresponding virtual keys on the display).

Of course, if the number of the desired communication party does not previously exist in the mobile terminal, also experienced user will have to use manual dialing.

Speed dial functionality has been developed to facilitate voice call initiation and is yet an alternative to the different call initiation methods referred to above. As is seen in FIG. 4, speed dial functionality involves associating a certain key of the (alpha-)numeric keypad with a certain telephone number of a desired communication party (step 400), and storing this association as a speed dial definition in local memory 410 in the mobile terminal (step 402).

From that on, if speed dial functionality has been defined for a certain key, the user may conveniently actuate this key (step 422) to initiate a call to the desired communication party. If the currently active application in the mobile terminal is one for which the (alpha-)numeric keypad has no meaning or another meaning that call handling, the user may first have to perform certain commands to return to the idle screen (or call handling application) (step 420). Once speed dial actuation of the certain key has been detected in step 422, software in the mobile terminal will search the local memory 410 for an existing speed dial definition for that key (step 424). If such a speed dial definition exists (step 426), the associated telephone number will be read from local memory and used for initiating a call to this number (step 428). During the call establishment, information will typically be presented on a display screen 700 (FIG. 7a) with some information to reflect the progress of the call establishment, for instance a brief information message 720 containing the dialed number and the name of the dialed person, perhaps combined with a progress bar 722. If, however, no speed dial definition has been made for the certain key, execution will end after step 426, and the user will at best be presented with a brief information message 724 to notify him that speed dial cannot be performed (FIG. 7b), but no further assistance will be offered to him.

Speed dial functionality is described for instance in GB-2 278 756. Here, a long-press of a certain key (i.e., depressing the certain key and keeping is depressed for a period of time in excess of a threshold value) will invoke speed dial functionality, whereas a normal actuation (short-press) of the certain key will be interpreted as the normal meaning of that key (e.g. inputting a digit “3”, to whatever application is active, if (alpha-)numeric key “3” is pressed). In some existing mobile terminal models, speed dial functionality is instead invoked by depressing a certain key followed by actuation of a special key, such as a “Call”, “Yes” or “OK” key.

For users that have difficulties in using any of the call initiation methods above, and where no existing speed dial functionality is defined for a desired communication party, the prior art offers one final alternative to establish such a call, namely to place a call to a remote call assistance service, typically provided at a charge by the mobile network operator. As seen in FIG. 5, the user of the mobile terminal will initiate a call to the remote service in step 500, normally by dialing the number to that service manually. Upon receipt of the incoming call from the mobile terminal, in step 502 an operator at the remote service will ask the user who he wants to call. The user of the mobile terminal responds in step 504 by providing sufficient information about the desired communication party, such as full or partial name(s), residential or business address, etc. Based on this information, the operator at the remote service will perform a search in a central database 507, typically containing subscriber data for a large number of telecommunication subscribers. The database may be integrated, distributed or clustered with other network operator databases to increase the volume of searchable subscriber data.

If the information provided from the mobile terminal user results in a match in the aforementioned database search, contact details about the desired communication party are obtained from the database 507 in step 508. Traditionally, such remote call assistance service ends with the operator reading out the found contact details verbally to the mobile terminal user (step 510a). Alternatively or in addition, some network operators offer to send the found contact details as an electronic message, typically SMS, to the mobile terminal user (step 510b) for receipt by a messaging application therein. Finally, alternatively or in addition, the operator may offer to establish communication with the desired communication party by setting up a call between the user's mobile terminal and a telephone device indicated by a caller identity (telephone number) included in the found contact details (step 510c).

If alternative 510a and/or 510b is available and chosen, the mobile terminal user may at some later stage create a new contact record in the mobile terminal's phonebook, enter the contact details supplied from the remote service and store them in phonebook memory (step 512). As a separate and following step 514, the mobile terminal user may finally define speed dial functionality for the new contact record by assigning a speed dial key to the caller identity of the contact.

The prior art approach of FIG. 5 is disadvantageous, particularly for users of the less experienced categories referred to above, in that it requires several steps of active intervention from the user of the mobile terminal. First, he has to initiate a call to the remote call assistance service. Then, to avoid having to use the remote service again (and pay the associated service charge once more) when a future call to the same communication party is desired, he must take the measures of steps 512 and 514 to store sufficient contact details of the desired communication party and create a speed dial definition for future use.

In case the remote service delivers the resulting contact details by reading them out verbally (step 510a), the user must either remember the details or make a note of them in preparation of steps 512 and 514.

Even if the resulting contact details are delivered electronically as e.g. an SMS message, several operations in the user interface are required by the user, in several different applications, in order to perform steps 512 and 514. The different items of the contact details (such as name, telephone number and address) must be read one by one, and either be temporarily remembered or, at best, be copied electronically using copy and paste functionality, and then be entered into the corresponding fields of the contact record by switching back and forth between the messaging application and the phonebook application. Then, the user must perform the actions necessary for defining the speed dial functionality in step 514, typically available as menu options in a call handling application or control panel application. Having to perform all these actions is clearly cumbersome for the user and particularly difficult to less experienced users.

### SUMMARY

In view of the above, it would be advantageous to solve or at least reduce the problems discussed above. In more particular, the aspects of the disclosed embodiments provide an improved and automated manner of giving speed dial assistance to a user of a mobile terminal In one embodiment, this is achieved by methods for speed dial configuration of a mobile terminal for a mobile communications network, and an associated mobile terminal, remote service apparatus, system and computer program according to the attached independent patent claims.

Briefly speaking, from one point of view the disclosed embodiments may be described as a cooperation between a mobile terminal and a network operator's remote service that assists the mobile terminal user in getting the speed dial numbers in use. If a speed dial number for a specific key has not been assigned, the terminal automatically calls the remote service, letting the user say the desired person's name to the operator personnel at the remote service, who will determine caller details of the desired person by a database search. The remote service connects the call between the terminal and the desired person, and a configuration message is sent to the user's terminal which will save the caller details automatically and create a speed dial definition between the specific speed dial key and the caller details of the desired person.

A first aspect of the disclosed embodiments is a method for speed dial configuration of a mobile terminal for a mobile telecommunications network, the method involving the steps, in said mobile terminal, of:

detecting a speed dial command from a user of said mobile terminal;

establishing communication with a remote service over said mobile telecommunications network;

providing said remote service with first information pertaining to a desired communication party;

receiving configuration data containing second information pertaining to said desired communication party from said remote service, said second information including a caller identity (such as a telephone number) of said desired communication party; and

configuring said mobile terminal for future speed dialing to said desired communication party by storing, in local memory in said mobile terminal, an association between said speed dial command and said caller identity.

Such speed dial configuration is advantageous, since it will allow the user of the mobile terminal to conveniently perform the thus configured speed dial command the next time he wants to place a call to the desired communication party, wherein the association stored in the memory will be used automatically by the terminal for retrieving the caller identity to use when initiating such a call to the desired communication party.

Advantageously, the mobile terminal is of a type having a user interface that includes a plurality of keys, wherein said step of detecting a speed dial command involves detecting actuation of one of said plurality of keys.

In one embodiment, said plurality of keys is a keypad with (alpha-)numeric keys of a type commonly known as ITU-T. Advantageously, the actuation of the key in question may be detected as a long-press actuation of the key, i.e. that the key is maintained depressed for a certain period of time that exceeds a predetermined duration. Alternatively, the actuation of the key in question may be detected as a normal (short-press) actuation of the key, followed by an affirmative action, such as actuation of a call establishment key like “Yes”, “OK” or “Call” (such a call establishment key may either be a dedicated key that has this meaning constantly, or a functional key (soft key) that has this meaning only in the relevant context (e.g. call handling application/idle screen.

In other embodiments, however, said step of detecting a speed dial command may involve detecting actuation of another kind of input element, for instance a mechanical key which is physically depressible and the actuation of which is detected e.g. by the closing of an electric contact or circuit, or a touch-sensitive key the actuation of which is detected by e.g. piezoelectric, capacitive, optical or magnetic means, or actuation of a multi-way navigation element like a joystick, four-way/five-way navigation key or rotator input device.

In one embodiment, said first information pertaining to a desired communication party is provided to said remote service in the form of voice data from said user. In other embodiments, the first information may be provided in the form of digital text representing an input made by the user of the mobile terminal.

In one embodiment, said second information pertaining to said desired communication party is received from said remote service in the form of at least one electronic message, which may be selected from the group consisting of: Short Messaging Service (SMS), Multimedia Messaging Service (MMS), email, and http/wap push data.

In one embodiment, said step of detecting a speed dial command from a user of said mobile terminal involves recording said speed dial command, or a representation thereof, in said local memory, wherein said step of configuring said mobile terminal for future speed dialing uses the thus recorded speed dial command, or its representation.

In another embodiment, the speed dial command detected in said step of detecting, or a representation thereof, is provided to said remote service from said mobile terminal (e.g. included in the first information), wherein said speed dial command, or a representation thereof, is furthermore included in the second information received from said remote service and is used in said step of configuring said mobile terminal for future speed dialing.

Said step of detecting a speed dial command may further involve searching said local memory in said mobile terminal to determine whether there is a predefined communication party associated with said speed dial command, and if so, initiating a call from said mobile terminal to the predefined communication party instead of performing said steps of establishing, providing, receiving and configuring.

Advantageously, the method further involves, after said step of providing said remote service with first information pertaining to a desired communication party, a step of accepting an attempt from said remote service to establish communication between said mobile terminal and said desired communication party.

A second aspect of the disclosed embodiments is a method for speed dial configuration of a mobile terminal for a mobile telecommunications network from a remote service coupled to said mobile telecommunications network, the method involving the steps, at said remote service, of:

accepting an attempt from said mobile terminal to establish communication with said remote service over said mobile telecommunications network;

prompting said mobile terminal to provide first information pertaining to a desired communication party;

receiving said first information;

searching a database for second information pertaining to said desired communication party as indicated by said first information, said second information including a caller identity of said desired communication party; and

transmitting said second information to said mobile terminal in the form of configuration data capable of causing storage in said mobile terminal of an association between a speed dial command and said caller identity to configure said mobile terminal for future speed dialing to said desired communication party.

The speed dial command is advantageously provided by a user of said mobile terminal and causes said attempt by said mobile terminal to establish communication with said remote service.

One embodiment further involves receiving said speed dial command, or a representation thereof, from said mobile terminal, wherein said step of transmitting said second information to said mobile terminal in the form of configuration data involves including said speed dial command, or its representation, in said configuration data. Such a (representation of) the particular speed dial command actuated by the mobile terminal user may be communicated to the remote service as computer-readable data, for instance encoded as corresponding DTMF (Dual Tone Multi Frequency) tone(s).

In one embodiment, said first information pertaining to a desired communication party is received in the form of voice data from a user of said mobile terminal.

One embodiment involves the further steps of performing voice recognition on said first information so as to derive a computer-readable representation of said first information, and inputting said computer-readable representation to said step of searching a database for second information.

Said configuration data may be transmitted to said mobile terminal in the form of at least one electronic message, for instance selected from the group consisting of: Short Messaging Service (SMS), Multimedia Messaging Service (MMS), email, and http/wap push data.

The method may further involve, after said step of searching a database for second information pertaining to said desired communication party, a step of initiating a call establishment between the mobile terminal and the desired communication party, as indicated by said caller identity.

A third aspect of the disclosed embodiments is a mobile terminal having a processing device, a memory and a wireless interface adapted for communication with a mobile telecommunications network, wherein the processing device is adapted to perform a method according to the second aspect.

The processing device may be a CPU (“Central Processing Unit”), DSP (“Digital Signal Processor”) or any other electronic programmable logic device or combination of devices. The memory may be an electronic memory such as RAM memory, ROM memory, EEPROM memory, flash memory, or any combination thereof.

The third aspect generally has the same or corresponding features and advantages as the first aspect.

A fourth aspect of the disclosed embodiments is a remote service apparatus for speed dial configuration of a mobile terminal for a mobile telecommunications network, wherein the apparatus has means for performing a method according to the third aspect.

The fourth aspect generally has the same or corresponding features and advantages as the second aspect.

A fifth aspect of the disclosed embodiments is a system for speed dial configuration of a mobile terminal for a mobile telecommunications network from a remote service coupled to said mobile telecommunications network, the system comprising a mobile terminal according to the third aspect, and a remote service apparatus according to the fourth aspect.

A sixth aspect of the disclosed embodiments is a computer program, comprising computer program code for performing the steps of the method according to the second aspect.

The mobile terminal in any of the aspects discussed above may be a portable telecommunication apparatus such as a mobile telephone, personal digital assistant (PDA), etc, for a mobile telecommunication system like GSM, UMTS, D-AMPS, CDMA2000, FOMA or TD-SCDMA.

Other features and advantages of the disclosed embodiments will appear from the following detailed disclosure, from the attached dependent claims as well as from the drawings.

Generally, all terms used in the claims are to be interpreted according to their ordinary meaning in the technical field, unless explicitly defined otherwise herein. All references to “a/an/the [element, device, component, means, step, etc]” are to be interpreted openly as referring to at least one instance of said element, device, component, means, step, etc., unless explicitly stated otherwise. The steps of any method disclosed herein do not have to be performed in the exact order disclosed, unless explicitly stated.

### BRIEF DESCRIPTION OF THE DRAWINGS

Embodiments of the disclosed embodiments will now be described in more detail, reference being made to the enclosed drawings, in which:

FIG. 1 is a schematic illustration of a telecommunications system, including a mobile terminal, a remote service for assisted speed dial and a mobile telecommunications network, as an example of an environment in which the disclosed embodiments may be applied.

FIG. 2 is a schematic block diagram illustrating a mobile terminal according to one embodiment.

FIG. 3 is a schematic front view illustrating the external front surface appearance of the mobile terminal of FIG. 2 in more detail.

FIG. 4 is a flow chart which illustrates a prior art method of speed dial configuration and use in a mobile terminal.

FIG. 5 is a flow chart which illustrates remote call assistance service for a mobile terminal according to the prior art.

FIG. 6 is a flow chart which illustrates a speed dial configuration method involving a mobile terminal and a remote assisted speed dial service according to one embodiment.

FIGS. 7a and 7b are schematic display screen snapshots of the prior art, taken when a user of a mobile terminal actuates a key that has defined speed dial functionality, and a key for which no speed dial functionality is defined, respectively.

FIGS. 8a-8d are schematic display screen snapshots taken for a mobile terminal during performance of a speed dial configuration method according to one embodiment of the disclosed embodiments.

### DETAILED DESCRIPTION OF THE INVENTION

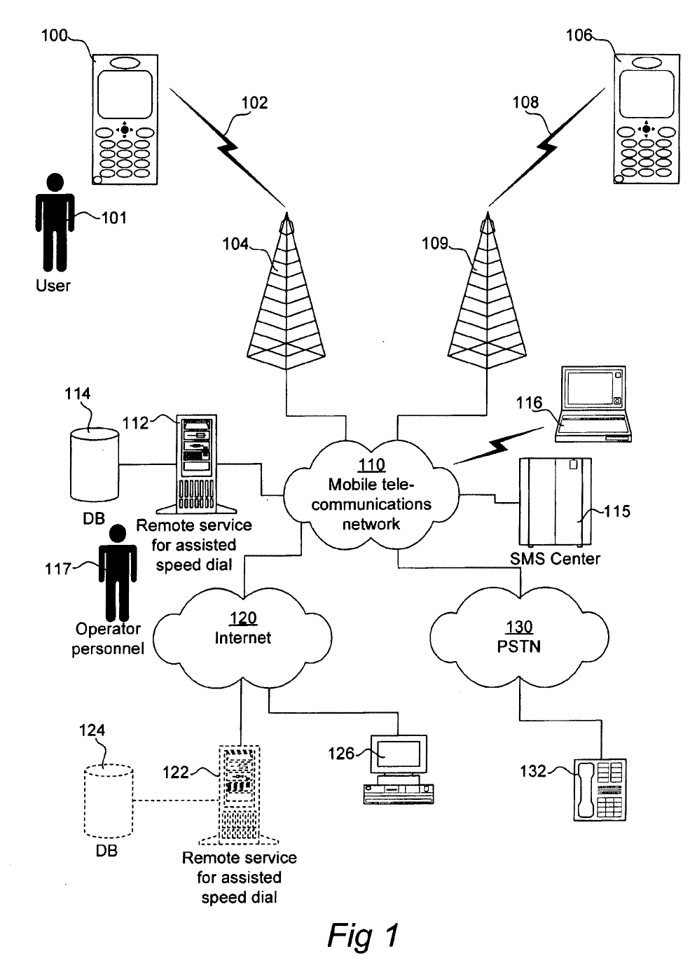

FIG. 1 illustrates one example of a telecommunications system in which the disclosed embodiments may be applied. In the telecommunications system of FIG. 1, various telecommunications services such as voice calls, data calls, facsimile transmissions, music transmissions, still image transmissions, video transmissions, electronic message transmissions and electronic commerce may be performed to and from different mobile terminals 100, 106. Among these services, telephone calls and electronic message transmissions are of more importance for the disclosed embodiments.

In the following, a voice call will be used as one example of an attempt to establish communication, but other types of telephone calls such as data or facsimile calls are also possible. Furthermore, an SMS message will be used in the description, but other types of electronic messages, including but not limited to MMS and email messages, are also possible.

The mobile terminals 100, 106 are connected to a mobile telecommunications network 110 through RF links 102 and 108 via respective base stations 104, 109. The mobile telecommunications network 110 may belong to any commercially available mobile telecommunications system, in compliance with standards such as GSM, UMTS, D-AMPS, CDMA2000, FOMA or TD-SCDMA. The mobile terminals 100, 106 are illustrated as mobile (cellular) telephones but may alternatively be other kinds of portable devices, such as personal digital assistants or communicators.

A public switched telephone network (PSTN) 130 is connected to the mobile telecommunications network 110 in a familiar manner. Various telephone terminals 132 are connected to the PSTN 130.

The mobile telecommunications network 110 is operatively connected to a wide area network 120, which may be Internet or a part thereof. Various client computers 126 may be connected to the wide area network 120.

A remote service 112 for providing assisted speed dial services in accordance with the disclosed embodiments is provided by the operator of the mobile telecommunications network 110. In the disclosed embodiment, the remote service 112 involves a server computer and an associated database 114 which contains subscriber data on a plurality of telecommunication subscribers. Operator personnel 117 is available in the disclosed embodiment to perform tasks among the assisted speed dial services that involve manual service. However, such operator personnel 117 may be dispensed with in other, fully automated embodiments. To increase the volume of searchable subscriber data, the database 114 may contain not only subscriber data pertaining to the network operator's own subscribers, but also subscriber data pertaining to subscribers of other telecommunication service providers, including operators that provide mobile telecommunication services, PSTN-based services and/or Internet-based telecommunication services (such as VoIP, Voice over IP). Additionally or alternatively, the remote service may be distributed or clustered and include also server computers and subscriber databases of such other telecommunication services, as is exemplified by server computer 122 and database 124 in FIG. 1.

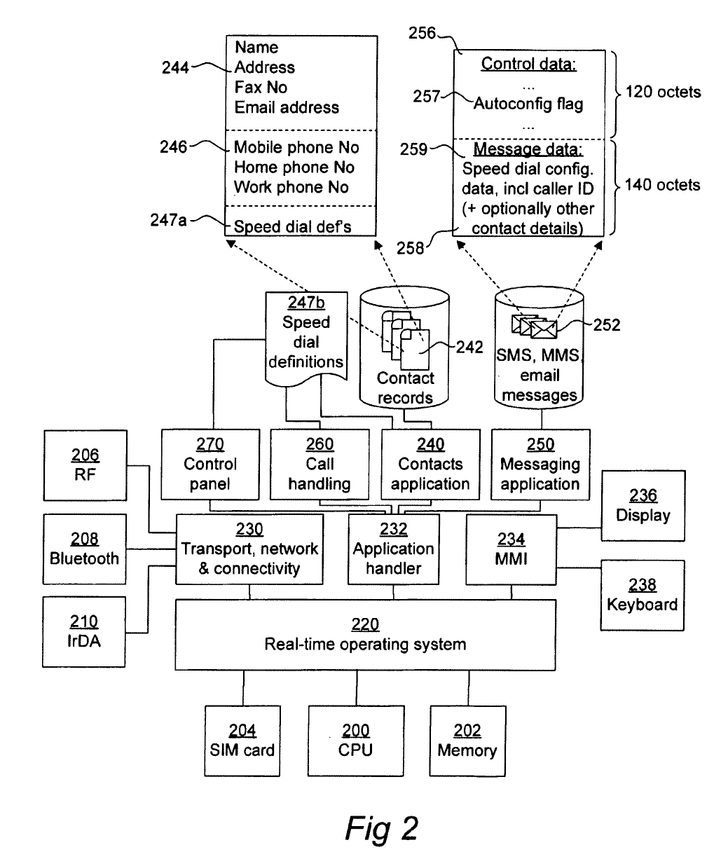

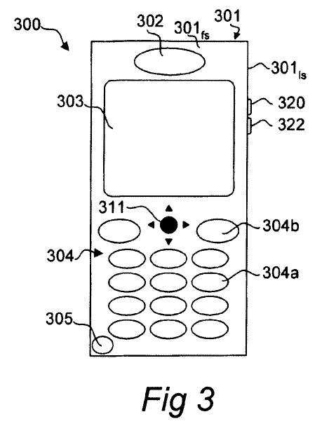

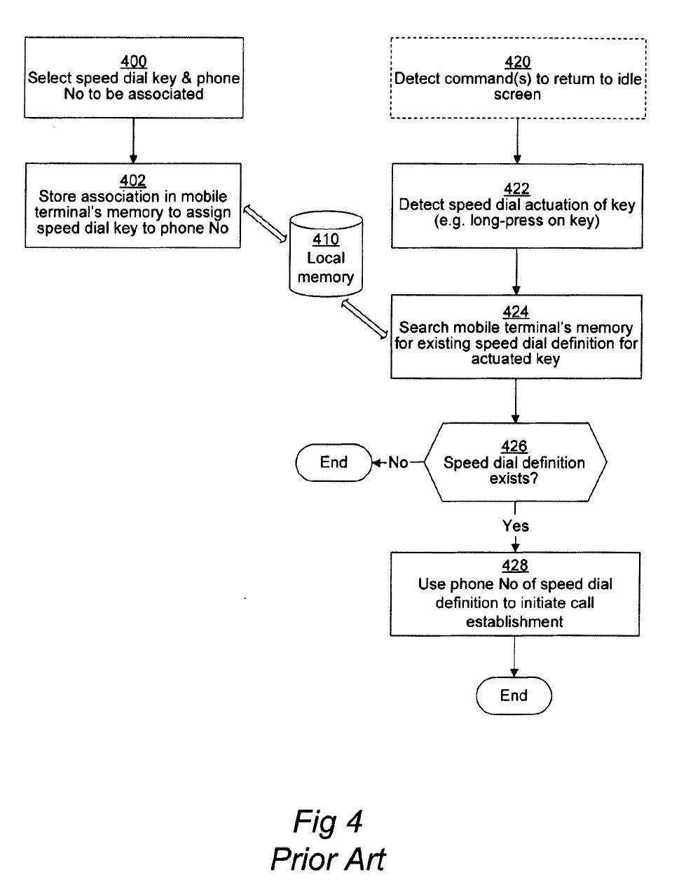

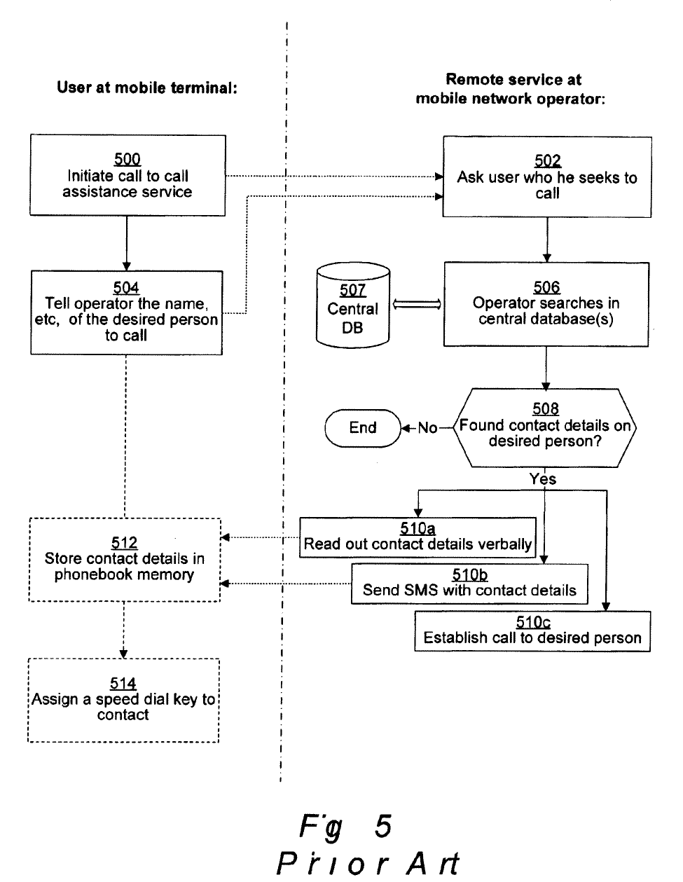

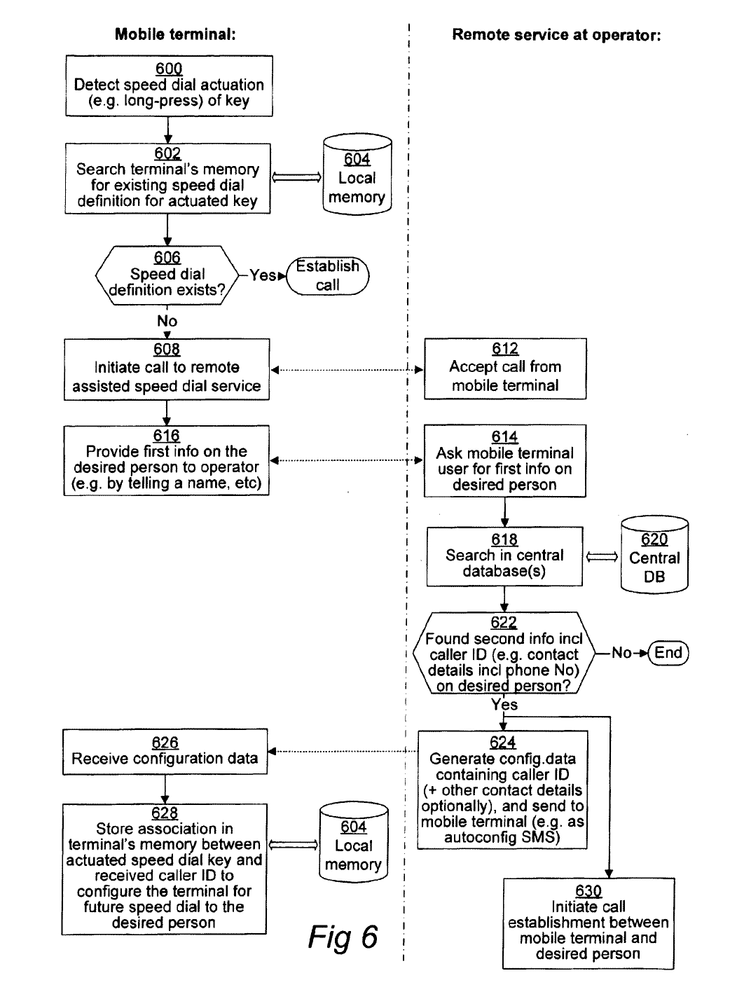

As will be described in more detail with reference to FIG. 6, the remote service 112 is adapted to provide assisted speed dial service, involving automatic speed dial configuration for future use, when a user of a mobile terminal, such as user 101 of terminal 100 in FIG. 1, performs a speed dial command for which there is no existing speed dial definition in the mobile terminal. First, however, details about the internal and external constitution of the mobile terminal 100 will be given with reference to FIGS. 2 and 3.

As seen in FIG. 2, the mobile terminal 100 has a controller 200 which is responsible for the overall operation of the mobile terminal and is preferably implemented by any commercially available CPU (“Central Processing Unit”), DSP (“Digital Signal Processor”) or any other electronic programmable logic device. The controller 200 has associated electronic memory 202 such as RAM memory, ROM memory, EEPROM memory, flash memory, or any combination thereof. The memory 202 is used for various purposes by the controller 200, one of them being for storing data and program instructions for various software in the mobile terminal. The software includes a real-time operating system 220, man-machine interface (MMI) drivers 234, an application handler 232 as well as various applications. The applications include a contacts (phonebook) application 240, a messaging application 250, a call handling application 260 and a control panel application 270, as well as various other applications which are not central to the disclosed embodiments. The MMI drivers 234 cooperate with conventional MMI or input/output (I/O) devices, including a display 236 and a keyboard 238 as well as various other I/O devices such as a microphone, a speaker, a vibrator, a joystick, a ringtone generator, an LED indicator, etc. As is commonly known, a user may operate the mobile terminal through the man-machine interface thus formed. A detailed description of the external components of the man-machine interface will be described in more detail with reference to FIG. 3.

The software also includes various modules, protocol stacks, drivers, etc., which are commonly designated as 230 and which provide communication services (such as transport, network and connectivity) for an RF interface 206, and optionally a Bluetooth interface 208 and an IrDA interface 210. The RF interface 206 comprises an internal or external antenna as well as appropriate radio circuitry for establishing and maintaining a wireless link to a base station (e.g. the link 102 and base station 104 in FIG. 1). As is well known to a man skilled in the art, the radio circuitry comprises a series of analogue and digital electronic components, together forming a radio receiver and transmitter. These components include, inter alia, band pass filters, amplifiers, mixers, local oscillators, low pass filters, AD/DA converters, etc.

The mobile terminal also has a SIM card 204 and an associated reader. As is commonly known, the SIM card 204 comprises a processor as well as local work and data memory.

The contacts application 240 handles a plurality of contact entries or records 242, which are stored in the memory 202. In the embodiment of FIG. 2, each contact record 242 has a plurality of data fields 244, 246, such as a Name field, an Address field, a Fax No field and an Email address field 244, and a Mobile phone No field, a Home phone No field and a Work phone No field 246. Among these field, the fields 246 each contain a caller identity of a communication party to which a call establishment may be initiated by speed dial, provided that a speed dial definition is either existing in the mobile terminal for that caller identity, or is provided by the remote service 112 in accordance with the disclosed embodiments. Such speed dial definitions may be stored as data 247a within the contact record 242, or in a separate list 247b which is available to the call handling application 260.

A speed dial definition 247a or 247b typically associates a certain speed dial command, such as a long-press on any (alpha-)numeric key 304a (FIG. 3), with a certain caller identity, such as a mobile phone No, Home phone No or Work phone No. Such an association may either contain the caller identity in “hard-coded” form, like:

Speed dial key Caller identity

| | |
|---|---|
| “3” | +46123456789 |
| “7” | +46987654321 |

or by way of a pointer to a certain data field 246 in a certain contact record 242.

Depending on implementation, the speed dial definitions 247a or 247b may be readable and modifiable from any one of the contacts application 240, messaging application 250, call handling application 260 and control panel application 270, or from any combination of these.

The messaging application 250 handles a plurality of SMS messages, both unread messages and ones that have already been read/opened. The messages may be stored in memory 202 of the mobile terminal, in the internal memory of the SIM card 204, or in both. Stored SMS messages may also be transferred between one of these memories and the other.

FIG. 2 illustrates the composition of a typical SMS message 252 which has been received from the remote service 112 in the mobile terminal and contains auto-configuration data including contact details, e.g. caller identity (phone number), of a desired communication party. As will be described in more detail with reference to FIG. 6, the auto-configuration data will allow configuration of the mobile terminal for future speed dialing to the desired communication party. The SMS message 252 has a control data portion 256 and a message data portion 258.

The control data portion 256 occupies 120 octets and contains an auto-configuration flag 257 which allows the messaging application 250 to differentiate this message 252 from an ordinary text-carrying SMS message. The control data portion 256 also contains various protocol layer-specific and message type-specific control data.

The message data portion 258, which occupies 140 octets and is the payload of the SMS message, contains speed dial configuration data 259 including the caller identity of the desired communication party, as well as any auto-configuration data required for performing the speed dial configuration in the mobile terminal (again, this will be described in more detail with reference to FIG. 6).

For details about the format of SMS messages, reference is made to available standards for 2G, 2.5G and 3G mobile telecommunications systems. For instance, the SMS service for 3G systems is described in detail in “3GPP TS 24.011”, which is available at http://www.3gpp.org/.

The call handling application 260 handles various aspects of conventional voice calls, e.g. receiving and announcing incoming calls, generating outgoing calls, and keeping record of various call statistics such as recent calls lists. The call handling application may be integrated with idle screen functionality of the mobile terminal to be capable of providing functions that are typical for idle screen functionality, such as presentation of various status information and interception of various control commands from the user 101. Alternatively, the call handling application 260 may be invoked from the idle screen functionality whenever its services are needed.

The control panel application 270 allows for the user to adjust various settings in the mobile terminal. In some embodiments, it is possible to define speed dial functionality to create, modify or delete any speed dial definition 247a, 247b from the control panel application 270.

An embodiment 300 of the mobile terminal 100 is illustrated in more detail in FIG. 3. The mobile terminal 300 comprises an apparatus housing 301 with a front surface 301_{fs}, a speaker or earphone 302, a microphone 305, a display 303, and a set of keys 304 which includes a keypad of common ITU-T type ((alpha-)numerical keypad representing characters “0”-“9”, “*” and “#”) and certain other keys 304b such as soft keys and/or call handling keys (e.g. “Call”/“End”, “Yes”/“No”). The mobile terminal 300 moreover has a volume-up key 320 and a volume-down key 322 located at a long-side surface 301ₗₛ of the apparatus housing 301, between the front surface 301_{fs} and a rear surface (not shown). A multi-directional navigation input device 311 is provided next to the set of keys 304 below the display 303. In the disclosed embodiment the navigation input device 311 is a joystick, but in other embodiments it may be a four/five way navigation key, a rotator or a touch-pad, or be dispensed with.

Referring to FIG. 6, a method of providing speed dial configuration for a mobile terminal assisted by a remote service will now be described. Steps that are performed in the mobile terminal, such as the previously described mobile terminal 100, are shown to the left of the vertical dash-dotted line in FIG. 6, whereas steps that are performed at the remote service, such as the remote service 112 which has been referred to above, are shown to the right of this dash-dotted line.

In step 600, the mobile terminal detects that the mobile terminal user 101 has performed a speed dial actuation of an input device of the mobile terminal. In this example, it is assumed that the user performs this by long-pressing on one of the (alpha-)numeric keys 304a of the terminal's keyboard 238, or more specifically by long-pressing on the key representing character “3”. Speed dial actuation may however be performed in other ways, as has already been explained in the summary section of this document. Furthermore, in this example, it is assumed that the call handling application 260 (or idle screen functionality, if separate from the call handling application 260) detects this long-press of key “3” and performs also the following steps 602, 606, 608 and 616 in the mobile terminal.

In step 602, a search is made in local memory 604 of the mobile terminal for an existing speed dial definition for key “3”. More specifically, if speed dial definitions are stored as data 247a within the contacts records 242, the call handling application 260 will search all the contact records 242 for a match (or invoke a search function in the contacts application 240 to have it done). On the other hand, if speed dial definitions are stored in a separate list 247b, the call handling application 260 will search this list for a match.

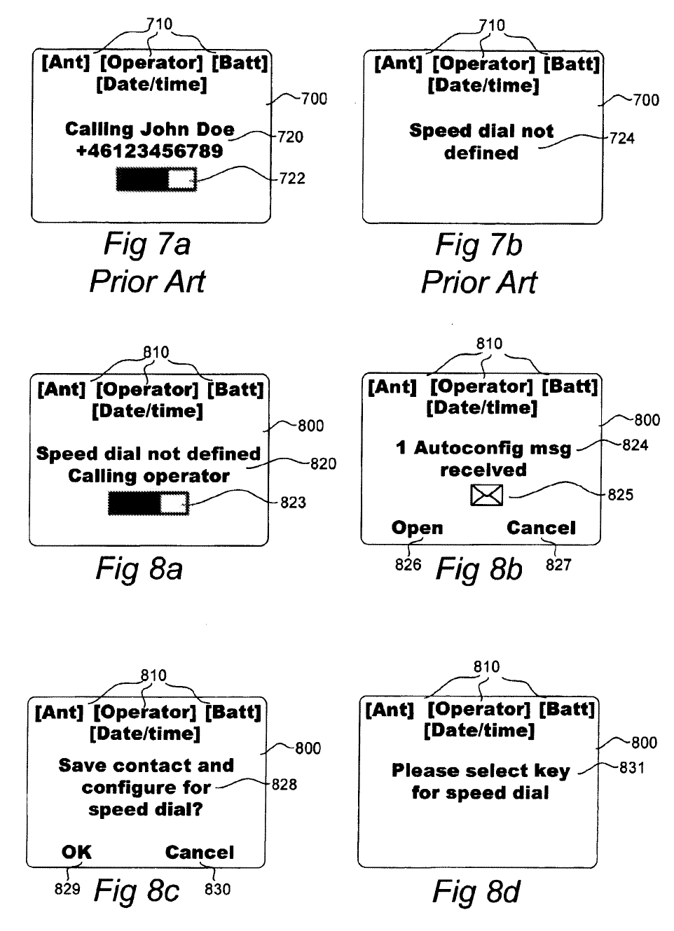

A check is made in step 606 to determine, based on the search in step 602, whether a speed dial definition exists for key “3”. If this is the case, a call to the associated caller identity found through the search in local memory, such as phone No “+46123456789”, is initiated in a conventional manner, and the user is presented with a display screen like the one in FIG. 7a.

If the check in step 606 is in the negative, i.e. speed dial is not presently defined for the long-pressed key “3”, execution proceeds to step 608. In step 608, a call is initiated from the mobile terminal 100 to the remote service 112 for assisted speed dial. At the same time, the user is presented with a display screen as shown in FIG. 8a. As seen in FIG. 8a, in addition to general status information 810 at the top of the display screen 800 (such as antenna/received signal strength indicator, the current network operator, a battery level indicator and the current date/time), an informative message 820 is shown. In contrast to the prior art approach of FIG. 7b, the user is not merely informed of the fact that no speed dial definition exists, but also of the fact that a call to the network operator's remote assisted speed dial service is initiated (further represented by a progress bar 823).

The number to be used by the call handling application 260 when dialing the remote service 112 may be predefined in the mobile terminal in any of a variety of different ways. For instance, it may have been configured by the network operator already before shipping the mobile terminal to the retail shops, or by way of an auto-configuration SMS message received and executed by the user at some time in the past, or by manually entering a setting in the control panel application 270. Alternatively, the number to the remote service 112 may be communicated to the mobile terminal upon system access, either the first time the mobile terminal accesses the network of a certain operator, or even each time system access is made. The latter alternative has an advantage in that it would make the remote assisted speed dial service operable even in situations of roaming.

The call initiation from the mobile terminal 100 is received at the remote service 112 in step 612. In the following example, the call is handled by a real person, namely operator personnel 117 of FIG. 1, who handles the tasks of steps 612, 614, 618, 622, 624 and 630 in cooperation with the server computer at the remote service 112 and associated software executed therein. In other embodiments, though, the steps 612, 614, 618, 622, 624 and 630 may be fully computerized and handled by the server computer and its associated software.

In step 614, the operator personnel 117 asks the mobile terminal user 101 who he seeks. In response, in step 616 the mobile terminal user 101 will provide first information about the desired communication party to the operator personnel 117, for instance by telling the full or partial name(s) and/or address(es) of the desired communication party. The first information is received at the remote service 112 at the end of step 614.

Based on the first information received from the mobile terminal, in step 618 the operator personnel 117 will conduct a search in central database(s) 620, which in the disclosed embodiment is aforesaid subscriber database 114 (and/or 124) of FIG. 1.

In step 622 it is determined whether a match for the first information has been found in the database search in step 618 and thus made available second information about the desired communication party. Such second information will typically be contact details for a subscriber whose subscriber data matches the first information from the mobile terminal user and who consequently is the desired communication party, the contact details including at least one caller identity in the form of a telephone number. In addition to the caller identity, the contact details may include for instance full name(s) and address(es) for the desired communication party. In case the second information contains more than one caller identity (for instance both home telephone number and mobile telephone number for a certain subscriber), the operator personnel 117 may ask the mobile terminal user 101 to specify the caller identity of interest. If more than one subscriber matches the first information, the operator personnel 117 may correspondingly ask for further information from the mobile terminal user to narrow the search results down to a single match.

If the determination in step 622 results in the affirmative, a step 624 of generating speed dial configuration data follows. Moreover, separately from this step, the operator personnel 117 may initiate a call establishment in step 630 between the (user of the) mobile terminal 100 and the desired communication party, as indicated by the caller identity in the second information obtained in step 618. Optionally, albeit not illustrated in FIG. 6, the operator personnel 117 may read out the second information verbally to the mobile terminal user 101.

Referring back to the step 624 of generating speed dial configuration data, in the disclosed embodiment, as has already been mentioned in the description of FIG. 2, this step involves generating an auto-configuration SMS message, having the mobile terminal 100 as receiver and containing the caller identity of the desired communication party, as derived from the second information obtained in step 618. As such, auto-configuration of mobile terminals by SMS messages is a well known technique, and the particulars thereof is omitted from this description in order not to obscure the disclosed embodiments in unnecessary detail. Reference is for instance made to the “Nokia-Ericsson smart messaging solution”, also known as Over-The Air technology (OTA), which has been in widespread use since 1997.

The auto-configuration flag 257 is set in the control data portion 256 of the SMS message to indicate to the intended receiver (the mobile terminal 100) that this SMS message is an auto-configuration message and not an ordinary text-carrying message.

The caller identity of the desired communication party, optionally together with the rest of the contact details from the second information, or certain parts thereof such as the name of the desired communication party, is put in the message data portion 258, as part of the speed dial configuration data 259 of FIG. 2. In addition, the speed dial configuration data 259 will contain any configuration control data necessary for performing the speed dial configuration data in the mobile terminal 100 upon receipt therein.

In the disclosed embodiment, such configuration control data includes an indication of which speed dial command (the (alpha-)numeric key “3” in the present example) to configure for future speed dialing to the caller identity in step 628 in the mobile terminal. Therefore, a representation of the actuated key “3” has already been communicated from the mobile terminal to the remote service in steps 608/612 by transmitting said representation as a sequence of DTMF tones during the call setup process.

Alternatively, other signals that are available according to the employed call setup protocol may be used during the call setup process to communicate the representation of the actuated key “3” to the remote service. As yet an alternative, the representation may be communicated during the actual call between mobile terminal and remote service in steps 616/614, either as computer-readable signals such as DTMF tones, or by simply letting the mobile terminal user 101 tell the operator personnel 117 which key he made a long-press on.

The auto-configuration SMS message thus generated in step 624 is transmitted over the mobile telecommunications network 110, and particularly an SMS center 115 thereof, to the mobile terminal 100. In step 626, the auto-configuration SMS message is received by the messaging application 250 of the mobile terminal 100. Since the auto-configuration flag 257 is set, the messaging application 250 treats the message as an auto-configuration message rather than an ordinary text-carrying one. Depending on implementation, speed dial configuration functionality for further processing of such a speed dial configuration message may be included in the messaging application 250, the contacts application 240, the call handling application 260, the control panel application 270, or be included in other software in the mobile terminal, such as the operating system 220. In some embodiments, the speed dial configuration functionality may be combined with other, existing auto-configuration functionality in the mobile terminal 100.

Furthermore, in some embodiments step 626 may also involve announcing receipt of the auto-configuration message on the display screen 800, as seen in FIG. 8b, in the form of an informative text 824 and a message envelope icon 825. Options 826 and 827 may be presented to allow the user 101 to either open the message (in this case, pass it on to the speed dial configuration functionality), or to neglect it for some reasons.

In step 628, the speed dial configuration functionality processes the speed dial configuration data 259 in the received auto-configuration message further. If the speed dial configuration data 259 simply contains the caller identity of the desired communication party together with the representation of the actuated speed dial key, an association between the two are stored automatically (possibly after seeking the user's approval through a user interface action) in the terminal's local memory 604 as a speed dial definition that will allow future speed dialing to the desired communication party when the user 101 actuates the speed dial key in question the next time. Thus, continuing with the example above, the (alpha-)numeric key “3” will be associated with the phone number “+46123456789”, either by adding a record in the speed dial definition list 247b, or by updating the speed dial definition field 247a within the contact record 242 of the desired communication party.

In the latter case, if no contact record 242 exists in local memory 604 (202) for the desired communication party, the speed dial configuration functionality may offer to create such a contact record and define the speed dial functionality thereof. Before doing this, a confirmation may be requested from the user 101, as illustrated at 828, 829 and 830 in FIG. 8c. Advantageously, if the speed dial configuration data 259 contains not only the caller identity of the desired communication party but also certain other contact details of the party, such details may be stored in the appropriate data fields 244, 246 of the generated contact record 242.

In embodiments where the speed dial configuration data 259 from the remote service 112 does not contain a representation of the actuated speed dial key, this information must be handled in another manner. In one embodiment, the call handling application 260 buffers or records a representation of the actuated speed dial key in local memory 604 (202) in step 608, i.e. when the call to the remote service 112 is initiated. Then, in step 628 the speed dial configuration functionality retrieves the buffered representation from local memory and uses it when storing the association between the caller identity and the actuated speed dial key, as indicated by the buffered representation.

In another embodiment, the speed dial configuration functionality prompts the user 101 in step 628 to indicate the speed dial key that was earlier actuated in step 600. A display screen 800 like in FIG. 8d may present a prompting message 831 to this effect.

In embodiments where no human operator personnel 117 is involved, computerized speech recognition and synthesis techniques commonly known per ser may be used for the interaction with the mobile terminal user 101 in step 614 (and steps 618 and 622 if more than search iteration is necessary because of multiple matches or multiple caller identities for one match).

In an alternative embodiment, the first information on the desired communication party is provided not as voice data but as text data by the user of the mobile terminal. One such application may be as follows.

The users enters a (whole or partial) name and/or address in an available text input field, such as a message field or address field in a display screen for generating a new message in the messaging application 250. Then, he performs a long-press on any unassigned speed dial key, or a dedicated call handling key. The entered text input is communicated to the remote service 112 in step 616 of FIG. 6, and the remainder of the speed dial configuration proceeds in essentially the same way as previously described. This embodiment is believed to be particularly beneficial for deaf and/or mute people.

The disclosed embodiments have mainly been described above with reference to a few embodiments. However, as is readily appreciated by a person skilled in the art, other embodiments than the ones disclosed above are equally possible within the scope of the disclosed embodiments, as defined by the appended patent claims.

1-23. (canceled)

24. A method for speed dial configuration of a mobile terminal for a mobile telecommunications network, comprising in said mobile terminal:
detecting a speed dial command from a user of said mobile terminal;
checking whether there is a predefined communications party associated with said speed dial command; and
if there is no predefined communications party associated with said speed dial command, performing the steps, in said mobile terminal, of:
establishing communication with a remote service over said mobile telecommunications network;
providing said remote service with first information pertaining to a desired communication party;
receiving configuration data containing second information pertaining to said desired communication party from said remote service, said second information including a caller identity of said desired communication party; and
configuring said mobile terminal for future speed dialing to said desired communication party by storing, in local memory in said mobile terminal, an association between said speed dial command and said caller identity.

25. A method as defined in claim 24, said mobile terminal having a user interface that includes a plurality of keys, wherein said step of detecting a speed dial command involves detecting actuation of one of said plurality of keys.

26. A method as defined in claim 24, wherein said first information pertaining to a desired communication party is provided to said remote service in the form of voice data from said user.

27. A method as defined in claim 24, wherein said second information pertaining to said desired communication party is received from said remote service in the form of at least one electronic message.

28. A method as defined in claim 27, wherein said at least one electronic message is selected from the group consisting of: Short Messaging Service (SMS), Multimedia Messaging Service (MMS), email, and http/wap push data.

29. A method as defined in claim 24,
wherein detecting a speed dial command from a user of said mobile terminal involves recording said speed dial command, or a representation thereof, in said local memory, and
wherein configuring said mobile terminal for future speed dialing uses the recorded speed dial command, or its representation.

30. A method as defined in claim 24,
wherein the speed dial command detected in said step of detecting, or a representation thereof, is provided to said remote service from said mobile terminal, and
wherein said speed dial command, or a representation thereof, is furthermore included in the second information received from said remote service and is used in said step of configuring said mobile terminal for future speed dialing.

31. A method as defined in claim 24, wherein said detecting a speed dial command further comprises
searching said local memory in said mobile terminal to determine whether there is a predefined communication party associated with said speed dial command, and wherein
said checking whether there is a predefined communications party associated with said speed dial command is based on said step of searching said local memory.

32. A method as defined in claim 24, further comprising
after checking whether there is a predefined communications party associated with said speed dial command, if there is a predefined communications party associated with said speed dial command, initiating a call from said mobile terminal to the predefined communication party instead of performing said steps of establishing, providing, receiving and configuring.

33. A method as defined in claim 24, further comprising, after providing said remote service with first information pertaining to a desired communication party, accepting an attempt from said remote service to establish communication between said mobile terminal and said desired communication party.

34. A method for speed dial configuration of a mobile terminal for a mobile telecommunications network from a remote service coupled to said mobile telecommunications network, comprising at said remote service:
accepting an attempt from said mobile terminal to establish communication with said remote service over said mobile telecommunications network;
prompting said mobile terminal to provide first information pertaining to a desired communication party;
receiving said first information;
searching a database for second information pertaining to said desired communication party as indicated by said first information, said second information including a caller identity of said desired communication party; and
transmitting said second information to said mobile terminal in the form of configuration data capable of causing storage in said mobile terminal of an association between a speed dial command and said caller identity to configure said mobile terminal for future speed dialing to said desired communication party.

35. A method as defined in claim 34, wherein said speed dial command is provided by a user of said mobile terminal and causes said attempt by said mobile terminal to establish communication with said remote service.

36. A method as defined in claim 35, further involving receiving said speed dial command, or a representation thereof, from said mobile terminal, wherein said transmitting (624) said second information to said mobile terminal in the form of configuration data (259) involves including said speed dial command, or its representation, in said configuration data.

37. The method of claim 34, wherein said first information pertaining to a desired communication party is received in the form of voice data from a user of said mobile terminal.

38. The method of claim 37, further comprises performing voice recognition on said first information so as to derive a computer-readable representation of said first information; and inputting said computer-readable representation to said step of searching a database for second information.

39. The method of claim 34, wherein said configuration data is transmitted to said mobile terminal in the form of at least one electronic message.

40. The method of claim 39, wherein said at least one electronic message is selected from the group consisting of: Short Messaging Service (SMS), Multimedia Messaging Service (MMS), email, and http/wap push data.

41. The method of claim 34, further involving, after searching a database for second information pertaining to said desired communication party, of initiating a call establishment between the mobile terminal and the desired communication party, as indicated by said caller identity.

42. A mobile terminal having a processing device, a memory and a wireless interface adapted for communication with a mobile telecommunications network, the processing device being configured to:
detect a speed dial command from a user of said mobile terminal;
check whether there is a predefined communications party associated with said speed dial command; and
if there is no predefined communications party associated with said speed dial command:
establish, through said wireless interface, communication with a remote service over said mobile telecommunications network;
provide said remote service with first information pertaining to a desired communication party;
receive configuration data containing second information pertaining to said desired communication party from said remote service, said second information including a caller identity of said desired communication party; and
configure said mobile terminal for future speed dialing to said desired communication party by storing, in said memory, an association between said speed dial command and said caller identity.

43. The mobile terminal of claim 42, wherein the processing device is further configured to:
detect a speed dial command from a user of said mobile terminal;
check whether there is a predefined communications party associated with said speed dial command; and
if there is no predefined communications party associated with said speed dial command, perform the steps, in said mobile terminal, of:
establishing communication with a remote service over said mobile telecommunications network;
providing said remote service with first information pertaining to a desired communication party;
receiving configuration data containing second information pertaining to said desired communication party from said remote service, said second information including a caller identity of said desired communication party; and
configuring said mobile terminal for future speed dialing to said desired communication party by storing, in local memory in said mobile terminal, an association between said speed dial command and said caller identity.

44. A remote service apparatus for speed dial configuration of a mobile terminal for a mobile telecommunications network, the apparatus comprising:
means for accepting an attempt from said mobile terminal to establish communication with said remote service apparatus over said mobile telecommunications network;
means for prompting said mobile terminal to provide first information pertaining to a desired communication party;
means for receiving said first information;
means for searching a database for second information pertaining to said desired communication party as indicated by said first information, said second information including a caller identity of said desired communication party; and
means for transmitting said second information to said mobile terminal in the form of configuration data capable of causing storage in said mobile terminal of an association between a speed dial command and said caller identity to configure said mobile terminal for future speed dialing to said desired communication party.

45. A remote service apparatus according to claim 44, further comprising means for:
detecting a speed dial command from a user of said mobile terminal;
checking whether there is a predefined communications party associated with said speed dial command; and
if there is no predefined communications party associated with said speed dial command, performing the steps, in said mobile terminal, of:
establishing communication with a remote service over said mobile telecommunications network;
providing said remote service with first information pertaining to a desired communication party;
receiving configuration data containing second information pertaining to said desired communication party from said remote service, said second information including a caller identity of said desired communication party; and
configuring said mobile terminal for future speed dialing to said desired communication party by storing, in local memory in said mobile terminal, an association between said speed dial command and said caller identity.

46. A system for speed dial configuration of a mobile terminal for a mobile telecommunications network from a remote service coupled to said mobile telecommunications network, the system comprising:
a mobile terminal configured to; detect a speed dial command from a user of said mobile terminal;
check whether there is a predefined communications party associated with said speed dial command; and
if there is no predefined communications party associated with said speed dial command:
establish, through said wireless interface, communication with a remote service over said mobile telecommunications network;
provide said remote service with first information pertaining to a desired communication party;
receive configuration data containing second information pertaining to said desired communication party from said remote service, said second information including a caller identity of said desired communication party; and
configure said mobile terminal for future speed dialing to said desired communication party by storing, in said memory, an association between said speed dial command and said caller identity; and
a remote service apparatus configured to;
accept an attempt from said mobile terminal to establish communication with said remote service apparatus over said mobile telecommunications network;
prompt said mobile terminal to provide first information pertaining to a desired communication party;
receive said first information;
search a database for second information pertaining to said desired communication party as indicated by said first information, said second information including a caller identity of said desired communication party; and
transmit said second information to said mobile terminal in the form of configuration data capable of causing storage in said mobile terminal of an association between a speed dial command and said caller identity to configure said mobile terminal for future speed dialing to said desired communication party.

47. A computer program product stored in a memory, comprising computer program code for detecting a speed dial command from a user of said mobile terminal;
checking whether there is a predefined communications party associated with said speed dial command; and
if there is no predefined communications party associated with said speed dial command, perform the steps, in said mobile terminal, of:
establishing communication with a remote service over said mobile telecommunications network;
providing said remote service with first information pertaining to a desired communication party;
receiving configuration data containing second information pertaining to said desired communication party from said remote service, said second information including a caller identity of said desired communication party; and
configuring said mobile terminal for future speed dialing to said desired communication party by storing, in local memory in said mobile terminal, an association between said speed dial command and said caller identity.
